(19) United States
(12) Patent Application Publication
(10) Pub. No.: US 2008/0127941 A1
(43) Pub. Date: Jun. 5, 2008

(54) Device for Damping Liquid Pressure Waves in an Element that Conducts and/or Stores Liquid

(76) Inventors: Uwe Iben, Gerlingen (DE); Klaus Habr, Marktheidenfeld (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/720,017

(22) PCT Filed: Nov. 18, 2005
(86) PCT No.: PCT/EP05/56046

§ 371 Date: May 23, 2007

(30) Foreign Application Priority Data
Nov. 23, 2004 (DE) 102004056414.0

(51) Int. Cl. F02M 55/04

(52) U.S. Cl. 123/447; 123/456; 239/533.3

(57) ABSTRACT

The invention relates to a device for damping liquid pressure waves in conduits and containers that conduct and/or store liquids, in particular in conduits and containers of injection systems in motor vehicles. To convert vibrational energy into thermal energy, at least one reflection surface for reflecting at least some of the liquid pressure waves is provided in the container or in the conduit in a region that is separate from the remainder of the container or the conduit.

### PRIOR ART

The invention relates to a device for damping liquid pressure waves in a liquid-carrying and/or -storing means, in particular in a line or a container of an injection system of a motor vehicle, as generically defined by the preamble to claim 1.

From the prior art, pulsation or vibration dampers in lines and containers that carry and/or store liquids are known, in which pressure waves can spread into additional elastic volumes, such as diaphragm reservoirs, bladder reservoirs, expanding hoses, and so forth, and the pressure energy is converted into deformation energy of the elastic volumes. It is also known to damp pressure waves by means of phase-shifted superposition (interference) of the pressure waves; this is achieved for instance in blowpipe resonators. Last but not least, liquid pressure waves can be reduced by means of active pulsation reduction using the operative principle of interference, for instance by generating the phase-shifted wave with the aid of a servo valve.

Such pressure waves in containers and lines, which as a rule include both longitudinal waves and transverse waves, generate flows whose flow direction depends on the location of the origin of the pressure waves. Particularly in common rail injection systems in self-internal igniting internal combustion engines, the problem arises that pressure waves generated at the end of the injection event and their reflections that can occur upon closure of the nozzles of the injectors, cause re-opening of the nozzle needle of the affected injector or cause unwanted coupling of different injectors.

One generic device is known from German Patent Disclosure DE 102 12 876 A1. It serves to damp pressure oscillations in a high-pressure collection chamber of a common rail injection system of a self-igniting internal combustion engine; it includes vibration-damping valves, which are disposed in connection conduits leading from the high-pressure collection chamber to injectors and are acted upon by springs, and which similarly to check valves prevent a pressure wave, occurring upon closure of the nozzle needle, from traveling back into the high-pressure collection chamber.

### ADVANTAGES OF THE INVENTION

The invention is based on the concept of converting the vibrational energy that exists in the pressure waves into thermal energy by means of single or multiple reflection at a reflection face, and conducting the pressure waves at the same time into a region that is separate from the remainder of the liquid-carrying and/or -storing means, in which region dissipation occurs, or the pressure waves are converted into heat. The invention can be implemented in arbitrary liquid-carrying and/or -storing means, for instance in lines or containers, and suitable reflection faces can be produced economically.

By the provisions recited in the dependent claims, advantageous refinements of and improvements to the invention defined by the independent claim are possible.

Especially preferably, the region separated from the remainder of the liquid-carrying and/or -storing means is formed by a return conduit, into whose inlet region the liquid pressure waves can be focused by means of a curved reflection face. The return conduit can end in a throttle restriction that discharges into the liquid-carrying and/or -storing means, which is in communication with an upstream or downstream region, referred to the reflection face and the direction of pressure wave propagation, of the liquid-carrying and/or -storing means and is disposed transversely to the propagation direction of the pressure waves in the container or line. The return conduit is embodied in a wall of the liquid-carrying and/or -storing means, and the curved reflection face is embodied on a reflection body that protrudes into the interior of the liquid-carrying and/or -storing means. By these provisions, a flow is induced between the focus and the throttle restriction, and the portion of the vibrational energy that remains after the reflection of the pressure waves at the reflection face is focused toward the return conduit and converted into heat at the throttle restriction. The direct component or in other words the constant component of the flow intrinsically undergoes no reflection of the reflection face and can flow onward with only slight losses. To present a sufficiently large reflection face to the pressure waves and at the same time to have a large enough flow cross section available for the direct component of the volumetric flow, between the reflection body and the wall of the liquid-carrying and/or -storing means, a flow cross section is left open, which can be widened by providing that the liquid-carrying and/or -storing means has a recess, in a region diametrically opposite the reflection body.

In an alternative embodiment, the reflection face can be formed by a plurality of open-pore bodies, disposed in labyrinthine fashion one after the other, and by inner walls of the open pores thereof, for repeated reflection of the liquid pressure waves. Here, the interiors of the pores function as the region that is separate from the remainder of the liquid-carrying and/or -storing means. Moreover, between the labyrinthine porous bodies themselves, the pressure waves are reflected back and forth, and in each case a portion of the pressure waves penetrates into the pores of the bodies in order to convert the vibrational energy into heat there. As a result, both inside the open pores through which the liquid flows and at the porous bodies themselves, a multiple reflection of the pressure waves takes place, causing them to “run down”. An open-pore body of this kind may for instance at least partially comprise a sintered material.

In a preferred application, a high-pressure collection chamber of a common rail injection system of a self-igniting internal combustion engine is provided with a device according to the invention.

The construction of the device according to the invention will be best seen clearly from the ensuing description of exemplary embodiments.

### DRAWING

In the drawing:

FIG. 1 is a cross-sectional view of a line that is provided with a device for damping liquid pressure waves in a preferred embodiment;

FIG. 2 is a cross-sectional view of a line that is provided with a device for damping liquid pressure waves in a further embodiment.

### DESCRIPTION OF THE EXEMPLARY EMBODIMENTS

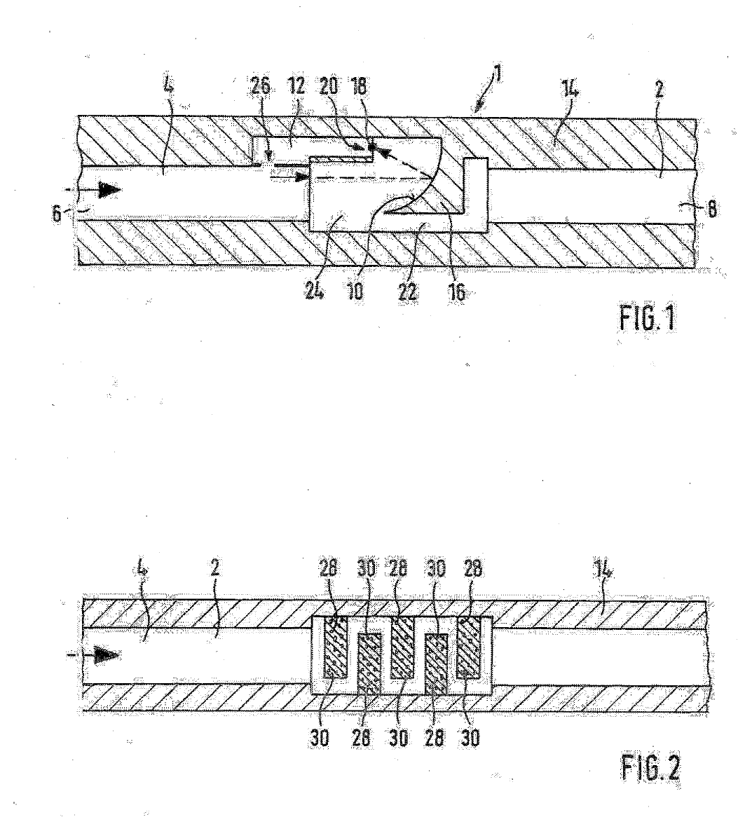

In FIG. 1, a preferred embodiment of a device 1 for damping liquid pressure waves in a line 2 that carries liquids, such as hydraulic oil or fuel, is shown. The line 2 has liquid flowing through it, for instance along a flow course 4, from an inlet 6 to an outlet 8. Alternatively, the device 1 may be associated with a container, which while it does store liquid, is nevertheless intended only for temporarily drawing and replenishing liquid. Such a container may for instance be formed by a high-pressure collection chamber of a common rail injection system of a self-igniting internal combustion engine that communicates fluidically with injectors which at defined injection instants inject fuel into combustion chambers or into an intake manifold of the engine, and replenishing fuel is pumped by a high-pressure pump. A common feature of such containers or lines 2 is that pressure fluctuations which cause liquid pressure waves occur because of flow processes or from the temporary drawing or replenishing of liquid. In the present exemplary embodiment of the line 2, it is assumed that the liquid pressure waves are propagated from the inlet 6 to the outlet 8 along the flow course 4.

According to the invention, to convert the vibrational energy of the liquid pressure waves into thermal energy, at least one reflection face 10 is provided in the line, for reflecting at least a portion of the liquid pressure waves into a region 12 that is separate from the remainder of the line 2.

The reflection face 10 is embodied for instance on a peglike reflection body 16, which protrudes from the wall 14 into the interior of the line 2, and has a curved shape such that liquid pressure waves propagating along the flow course 4 that have been reflected by the reflection face 10 are focused in a focusing region or focal point 18. As needed, a plurality of such reflection faces 10 or reflection bodies 16 may be connected in line with one another.

The focal point 18 is located in the region 12 that is separate from the remainder of the line; this region is formed for instance by a return conduit 12, into whose inlet region 20 the pressure waves are reflected. Between the reflection body 16 and the wall 14 of the line 2, a flow cross section 22 is left open. This can preferably be achieved by providing that the line 2 has a graduated recess 24 in a region diametrically opposite the reflection body 16.

The return conduit 12 is embodied for instance in the wall 14 of the line, and it extends parallel to the flow course 4. It also ends in a throttle restriction 26, which discharges transversely into the flow course 4 and is in communication with a region of the line 2 that is preferably upstream relative to the reflection face 10 and the direction of pressure wave propagation. Alternatively, the throttle restriction 26 may also be in communication with a downstream region of the line 2. Last but not least, the pressure wave energy downstream of the throttle restriction may also be conducted into a separate tie line, system line, or container that does not communicate with the line 2.

Against this background, the mode of operation of the device 1 is as follows: The portion of the vibrational energy that remains after the pressure waves are reflected by the reflection face 10 is focused toward the inlet region 20 of the return conduit 12 into the focal point 18, so that as a result, a flow in the line 2 between the focal point 18 and the throttle restriction 26 is induced that is oriented counter to the flow in the line 2. At the narrowed throttle restriction 26, the vibrational energy of the pressure waves that remain in the flow in the return conduit 12 is converted into heat. The direct component, that is, the constant component, of the flow in the line 2 conversely experiences no reflection at the reflection face 10 and can flow onward, with only slight losses, through the remaining flow cross section 22 in the recess 24.

In the second exemplary embodiment of the invention in FIG. 2, the elements that remain the same and function the same as in the previous example are identified by the same reference numerals. Here, first, the inner walls of open pores 28 of an open-pore region 30 in the line 2 serve as the reflection face 10 for repeated reflection of pressure waves inside the pores 28, whose interiors represent the region that is separate from the line 2. The open pores 28 are embodied in at least one open-pore body 30, which protrudes transversely away from the wall 14 of the line 2. For instance, a plurality of open-pore bodies 30 disposed in labyrinthine fashion one after another are disposed in the line 2, and the open-pore bodies 30 at least partially comprise a sintered material. The term “in labyrinthine fashion” should be understood here to mean a location of the bodies that is offset in the axial direction relative to the line 2, and these bodies additionally overlap one another partially in the radial direction.

By the porous bodies 30, the pressure wave is then partially converted into heat and partially reflected; because of the radial overlap of the bodies 30, the portion of the pressure wave that is not converted into heat is reflected to the particular porous body 30 diametrically opposite it and is there in turn partially converted into heat. As a result, both inside the open pores 28, through which the liquid flows, and at the porous bodies 30 themselves, multiple reflections of the pressure waves occur, causing them to “run down”. An open-pore body 30 of this kind may for instance at least partially comprise a sintered material.

1-12. (canceled)

13. A device for damping liquid pressure waves in a liquid-carrying line or container of an injection system of a motor vehicle, the device comprising at least one reflection face for reflecting at least a portion of the liquid pressure waves in a region that is separate from the remainder of the liquid-carrying and/or -storing means for converting vibrational energy into thermal energy in the liquid-carrying and/or -storing means.

14. The device as defined by claim 13, wherein the reflection face comprises a curved face, and wherein region separated from the remainder of the liquid-carrying and/or -storing means is formed by a line, a container, or a return conduit having an inlet region into which the liquid pressure waves can be focused by means of the curved reflection face.

15. The device as defined by claim 14, wherein the return conduit ends in a throttle restriction that discharges into the liquid-carrying and/or -storing means.

16. The device as defined by claim 15, wherein the throttle restriction is in communication with an upstream or downstream region relative to the reflection face and to the direction of pressure wave propagation, of the liquid-carrying and/or -storing means.

17. The device as defined by claim 15, wherein the return conduit is embodied in a wall of the liquid-carrying and/or -storing means.

18. The device as defined by claim 16, wherein the return conduit is embodied in a wall of the liquid-carrying and/or -storing means.

19. The device as defined by claim 17, wherein the curved reflection face is embodied on a reflection body that protrudes into the interior of the liquid-carrying and/or -storing means.

20. The device as defined by claim 18, wherein the curved reflection face is embodied on a reflection body that protrudes into the interior of the liquid-carrying and/or -storing means.

21. The device as defined by claim 19, wherein between the reflection body and the wall of the liquid-carrying and/or -storing means, a flow cross section is left open.

22. The device as defined by claim 20, wherein between the reflection body and the wall of the liquid-carrying and/or -storing means, a flow cross section is left open.

23. The device as defined by claim 21, wherein the liquid-carrying and/or -storing means comprises a recess, in a region diametrically opposite the reflection body.

24. The device as defined by claim 22, wherein the liquid-carrying and/or -storing means comprises a recess, in a region diametrically opposite the reflection body.

25. The device as defined by claim 13, wherein the reflection face is formed by a plurality of open-pore bodies disposed in labyrinthine fashion one after the other, whereby the inner walls of the open pores of the open-pore bodies produce repeated reflection of the liquid pressure waves.

26. The device as defined by claim 21, wherein the open-pore bodies protrude transversely away from a wall of the liquid-carrying and/or -storing means.

27. The device as defined by claim 25, wherein the open-pore bodies at least partly comprise a sintered material.

28. The device as defined by claim 26, wherein the open-pore bodies at least partly comprise a sintered material.

29. A high-pressure collection chamber of a common rail injection system of a self-igniting internal combustion engine, characterized in that it is provided with a device as defined by claim 13.

30. A high-pressure collection chamber of a common rail injection system of a self-igniting internal combustion engine, characterized in that it is provided with a device as defined by claim 19.

31. A high-pressure collection chamber of a common rail injection system of a self-igniting internal combustion engine, characterized in that it is provided with a device as defined by claim 25.

32. A high-pressure collection chamber of a common rail injection system of a self-igniting internal combustion engine, characterized in that it is provided with a device as defined by claim 27.
